(19) United States
(12) Patent Application Publication
(10) Pub. No.: US 2015/0237509 A1
(43) Pub. Date: Aug. 20, 2015

(54) CROWD SOURCING STRATEGY TO MINIMIZE SYSTEM BIAS

(71) Applicant: QUALCOMM Incorporated, San Diego, CA (US)

(72) Inventors: Hui CHAO, San Jose, CA (US); Yin Chen, Campbell, CA (US); Nima Noorshams, Santa Clara, CA (US); Ravi Palanki, Cupertino, CA (US)

(73) Assignee: QUALCOMM Incorporated, San Diego, CA (US)

(21) Appl. No.: 14/181,395

(22) Filed: Feb. 14, 2014

(51) Int. Cl. H04W 16/20; H04W 24/10; H04W 4/04; H04W 4/00

(52) U.S. Cl. CPC H04W 16/20; H04W 4/005; H04W 24/10; H04W 4/04

(57) ABSTRACT

Systems, apparatus and methods for deriving a heatmap in a server are presented. A heatmap is formed from sensor measurements and/or wireless signal strength measurements that have been grouped. Sensor measurements are paired or group into complementary sets thereby reducing sensor bias and/or system bias that is otherwise included because of sensor drift and unbalanced directional travel. Similarly, wireless signal strength measurements are paired or group into complementary sets also reducing system bias.

### BACKGROUND

I. Field of the Invention

This disclosure relates generally to systems, apparatus and methods for deriving a heatmap, and more particularly to minimizing system biases with different or complementary sensor measurements and/or complementary wireless signal strength measurements.

II. Background

Crowd sourcing is used in many indoor navigation venues for applications to learn locations of access points, detect whether a mobile device is indoors or outdoors, determine which floor plan to use, estimate a maps routing, etc. All of these applications require a user to carry their mobile device while the mobile device collects sensor measurements and wireless signal strength measurements. Sensor measurements include measurements from sensors such as an inertial measurement unit (IMU) and/or a magnetometer.

Unfortunately, sensors drift, which may accumulate over time. For example, an IMU may be biased in one direction or a magnetometer may consistently be off a set number of degrees. Also, a human body may interfere with wireless signal strength measurements. For example, the human body may introduce up to 10 dB of attenuation to wireless signal strength measurements. These inherent errors may introduce several meters of difference between an estimated position and an actual position.

What is needed are systems, apparatus and methods to remove sensor drift and/or attenuation caused by a human body, thereby minimizing system bias.

### BRIEF SUMMARY

Disclosed are systems, apparatus and methods for deriving a heatmap in a server.

According to some aspects, disclosed is a method in a server for deriving a heatmap, the method comprising: recording a first set of sensor measurements; recording a second set of sensor measurements; recording an extra set of sensor measurements, wherein the extra set of sensor measurements has no complement; determining the first set of sensor measurements and the second set of sensor measurements form a complementary set; forming the complementary set from the first set of sensor measurements and the second set of sensor measurements; and creating the heatmap using the complementary set while excluding the extra set of sensor measurements.

According to some aspects, disclosed is a server for deriving a heatmap, the server comprising: a receiver to receive: a first set of sensor measurements; a second set of sensor measurements; and an extra set of sensor measurements; and a processor to: determine the first set of sensor measurements and the second set of sensor measurements form a complementary set; form the complementary set from the first set of sensor measurements and the second set of sensor measurements; and create the heatmap using the complementary set while excluding the extra set of sensor measurements.

According to some aspects, disclosed is a method in a server for deriving a heatmap, the method comprising: recording a first wireless signal strength measurement; recording a second wireless signal strength measurement; recording an extra wireless signal strength measurement, wherein the extra wireless signal strength measurement has no complement; determining the first wireless signal strength measurement and the second wireless signal strength measurement form a complementary set; forming the complementary set from the first wireless signal strength measurement and the second wireless signal strength measurement; and creating the heatmap using the complementary set while excluding the extra wireless signal strength measurement.

According to some aspects, disclosed is a server for deriving a heatmap, the server comprising: a receiver to receive: a first wireless signal strength measurement; a second wireless signal strength measurement; and an extra wireless signal strength measurement; and a processor to: determine the first wireless signal strength measurement and the second wireless signal strength measurement form a complementary set; form the complementary set from the first wireless signal strength measurement and the second wireless signal strength measurement; and create the heatmap using the complementary set while excluding the extra wireless signal strength measurement.

### BRIEF DESCRIPTION OF THE DRAWING

Embodiments of the invention will be described, by way of example only, with reference to the drawings.

FIG. 1 illustrates a path in a hallway.

FIG. 2 illustrates a direct path between a mobile device and an access point.

FIG. 3 illustrates attenuation by a human body positioned between a mobile device and an access point.

FIG. 4 shows sensor measurements taken along two complementary paths, in accordance with some embodiments.

FIG. 5 shows sensor measurements taken along a loop, in accordance with some embodiments.

FIG. 6 shows complementary sensor measurements taken along two hallways, in accordance with some embodiments.

FIGS. 7 and 8 illustrate complementary and distributed measurements being saved to a heatmap database, in accordance with some embodiments.

FIG. 9 illustrates a direction of travel of a mobile device relative to an access point, in accordance with some embodiments.

FIGS. 10 and 11 show methods in a server for deriving a heatmap, in accordance with some embodiments.

FIG. 12 shows blocks of a server, in accordance with some embodiments.

### DETAILED DESCRIPTION

The detailed description set forth below in connection with the appended drawings is intended as a description of various aspects of the present disclosure and is not intended to represent the only aspects in which the present disclosure may be practiced. Each aspect described in this disclosure is provided merely as an example or illustration of the present disclosure, and should not necessarily be construed as preferred or advantageous over other aspects. The detailed description includes specific details for the purpose of providing a thorough understanding of the present disclosure. However, it will be apparent to those skilled in the art that the present disclosure may be practiced without these specific details. In some instances, well-known structures and devices are shown in block diagram form in order to avoid obscuring the concepts of the present disclosure. Acronyms and other descriptive terminology may be used merely for convenience and clarity and are not intended to limit the scope of the disclosure.

Position determination techniques described herein may be implemented in conjunction with various wireless communication networks such as a wireless wide area network (WWAN), a wireless local area network (WLAN), a wireless personal area network (WPAN), and so on. The term “network” and “system” are often used interchangeably. A WWAN may be a Code Division Multiple Access (CDMA) network, a Time Division Multiple Access (TDMA) network, a Frequency Division Multiple Access (FDMA) network, an Orthogonal Frequency Division Multiple Access (OFDMA) network, a Single-Carrier Frequency Division Multiple Access (SC-FDMA) network, Long Term Evolution (LTE), and so on. A CDMA network may implement one or more radio access technologies (RATs) such as cdma2000, Wideband-CDMA (W-CDMA), and so on. Cdma2000 includes IS-95, IS-2000, and IS-856 standards. A TDMA network may implement Global System for Mobile Communications (GSM), Digital Advanced Mobile Phone System (D-AMPS), or some other RAT. GSM and W-CDMA are described in documents from a consortium named “3rd Generation Partnership Project” (3GPP). Cdma2000 is described in documents from a consortium named “3rd Generation Partnership Project 2” (3GPP2). 3GPP and 3GPP2 documents are publicly available. A WLAN may be an IEEE 802.11x network, and a WPAN may be a Bluetooth network, an IEEE 802.15x, or some other type of network. The techniques may also be implemented in conjunction with any combination of WWAN, WLAN and/or WPAN.

A satellite positioning system (SPS) typically includes a system of transmitters positioned to enable entities to determine their location on or above the Earth based, at least in part, on signals received from the transmitters. Such a transmitter typically transmits a signal marked with a repeating pseudo-random noise (PN) code of a set number of chips and may be located on ground based control stations, user equipment and/or space vehicles. In a particular example, such transmitters may be located on Earth orbiting satellite vehicles (SVs). For example, a SV in a constellation of Global Navigation Satellite System (GNSS) such as Global Positioning System (GPS), Galileo, GLONASS or Compass may transmit a signal marked with a PN code that is distinguishable from PN codes transmitted by other SVs in the constellation (e.g., using different PN codes for each satellite as in GPS or using the same code on different frequencies as in GLONASS). In accordance with certain aspects, the techniques presented herein are not restricted to global systems (e.g., GNSS) for SPS. For example, the techniques provided herein may be applied to or otherwise enabled for use in various regional systems, such as, e.g., Quasi-Zenith Satellite System (QZSS) over Japan, Indian Regional Navigational Satellite System (IRNSS) over India, Beidou over China, etc., and/or various augmentation systems (e.g., an Satellite Based Augmentation System (SBAS)) that may be associated with or otherwise enabled for use with one or more global and/or regional navigation satellite systems. By way of example but not limitation, an SBAS may include an augmentation system(s) that provides integrity information, differential corrections, etc., such as, e.g., Wide Area Augmentation System (WAAS), European Geostationary Navigation Overlay Service (EGNOS), Multi-functional Satellite Augmentation System (MSAS), GPS Aided Geo Augmented Navigation or GPS and Geo Augmented Navigation system (GAGAN), and/or the like. Thus, as used herein an SPS may include any combination of one or more global and/or regional navigation satellite systems and/or augmentation systems, and SPS signals may include SPS, SPS-like, and/or other signals associated with such one or more SPS.

As used herein, a mobile device 100, sometimes referred to as a mobile station (MS 100) or user equipment (UE), such as a cellular phone, mobile phone or other wireless communication device, personal communication system (PCS) device, personal navigation device (PND), Personal Information Manager (PIM), Personal Digital Assistant (PDA), laptop or other suitable mobile device which is capable of receiving wireless communication and/or navigation signals. The term “mobile device 100” is also intended to include devices which communicate with a personal navigation device (PND), such as by short-range wireless, infrared, wireline connection, or other connection—regardless of whether satellite signal reception, assistance data reception, and/or position-related processing occurs at the device or at the PND. Also, “mobile device 100” is intended to include all devices, including wireless communication devices, computers, laptops, etc. which are capable of communication with a server, such as via the Internet, WiFi, or other network, and regardless of whether satellite signal reception, assistance data reception, and/or position-related processing occurs at the device, at a server, or at another device associated with the network. Any operable combination of the above are also considered a “mobile device 100.” A heatmap indicates an expected RF pathloss or RF signal strength received from an access point at several points on a map. A particular amount of attenuation along a path between the access point and a mobile device or the signal strength received at the mobile device may be mapped to a particular contour line of the heatmap and thus limits a position of the mobile device. A position of the mobile device may be further limited using trilateration from heatmaps of two or more additional access points. An overall heatmap is formed by overlaying heatmaps for each individual access point. A location of each access point may be known a priori or the heatmap may be used to locate individual access points. When using skewed or biased sensor measurements, a resulting heatmap may be similarly biased. For example, sensor measurements for mobile devices travelling in a common direction may introduce a common drift or sensor bias of sensor measurements and therefore skew a resulting heatmap. Using WiFi measurements from mobile devices travelling in a common direction may also favor a certain body attenuation.

Crowdsourcing provides a large number of sensor measurements and WiFi measurements. By pairing or grouping sensor measurements into complementary sets, the sensor bias may be reduced or removed from a heatmap. By requiring a number of WiFi measurements in complementary sets or from different directions, system bias may be reduced or removed from each heatmap.

A complementary set is two or more wireless measurements or two or more sensor measurements. A complementary set is collected with opposite, diverse or different moving directions, starting points or ending points and assumed to counter act error. That is, error in the measurements is assumed to cancel out, thus reducing or eliminating wireless or sensor error. For example, a complementary set may include two sets of sensor measurements, wherein the first set of sensor measurements are from a mobile device travelling from point A to point B and the second set of sensor measurements are from the mobile device travelling in the opposite direction from point B to point A. As another example, a complementary set may include more than two wireless signal strength measurements, wherein each wireless signal strength measurement comes from a mobile device on a different trajectory, wherein the different trajectories are separated by predetermined angle (e.g., 30, 45, 80 or 160 degrees). A complementary set may include only measurements from a single mobile device. Alternatively, a complementary set may include only measurements from similar mobile devices. Alternatively, a complementary set is not limited to a set of mobile devices. Wireless signal strength measurements may be adjusted by grouping and averaging the wireless signal strength measurements where some measurements are attenuation through a human body while other measurements that are not attenuation through the human body.

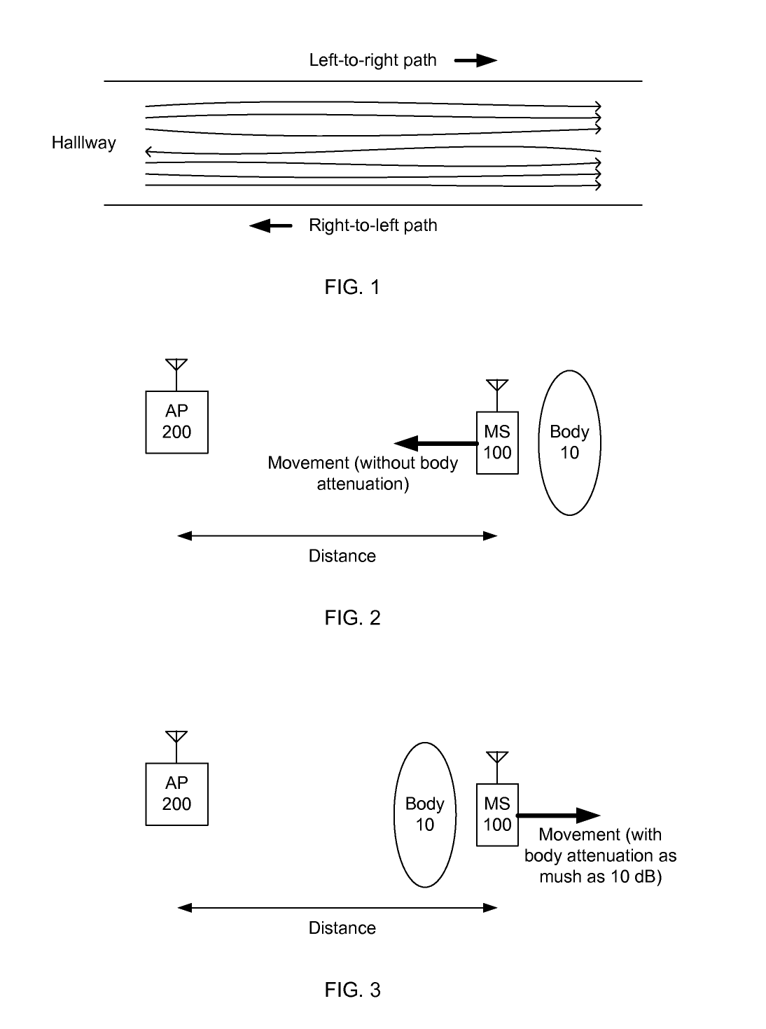

FIG. 1 illustrates a path in a hallway. Measurements are captured by the mobile device 100 along the path in hallway. Mobile devices 100 may travel from left to right or right to left. In this example, unbalanced directional travel is shown. Six mobile devices 100 travel from left to right and a single mobile device 100 travels from right to left. Sensor measurements may be paired such that sensor measurements from a left-to-right path are matched with sensor measurements from a right-to-left path. In this example, two sets of sensor measurements are paired and five left-to-right sensor measurements are extra. A heatmap created from paired sets of sensor measurements may cancel sensor bias and reduces system bias.

FIG. 2 illustrates a direct path between a mobile device 100 and an access point 200. In this case, a human body 10 does not attenuate a signal between a mobile device 100 and an access point 200. Any wireless signal strength measurements are not compensated or adjusted. Attenuation between the mobile device 100 and the access point 200 reflect an actual distance between the units.

FIG. 3 illustrates attenuation by a human body 10 positioned between a mobile device 100 and an access point 200. The path attenuation between the mobile device 100 and the access point 200 is adversely affected by the human body 10. If the mobile device 100 is positioned in a front pocket or holster worn at the front waist, wireless signal strength measurements may be lowered because of the body 10.

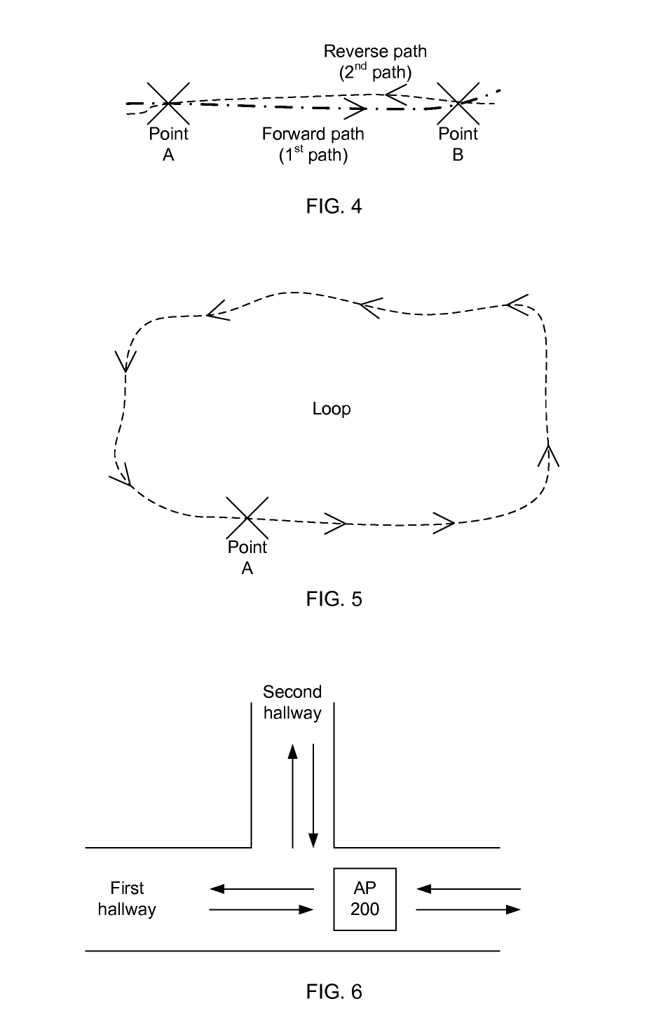

In the case of FIGS. 3 and 4, a mobile device 100 is assumed to be in front of a user. In other cases, a mobile device 100 is in a back pocket, bag or hand of a user. Bias due to the human body may be minimized by creating a heatmap from WiFi measurements just mobile devices 100 going in each possible direction and then averaging these WiFi measurements. For example, if an access point is positioned in an east-west hallway, a heatmap may require an equal number of eastward users travelling away from the access point, eastward users travelling towards the access point, westward users travelling away from the access point, and westward users travelling towards the access point. That is, an equal number of WiFi measurements from users travelling in each direction away from an access point as users travelling in each of the directions towards the access point. If the access point is positioned in a hallway, the heatmap for the particular access point may require WiFi measurements from for one or more users travelling in four directions as just described. If the access point is positioned at a four-way intersection, the heatmap for an access point may require WiFi measurements from for one or more users travelling in eight directions. If an access point is positioned at the edge of a room, a heatmap may require one or more pairs of WiFi measurements travelling in opposite directions or different directions. By averaging pairs or sets of WiFi measurements, body attenuation is mitigated. One or more previous locations and/or a current location may help to determine a relative position and trajectory of a mobile device 100 relative to a position and trajectory of another mobile device 100. Alternatively, the assumed body attenuation may be added back into the wireless signal strength measurements based on a direction, such as a direction of travel or an orientation of the mobile device 100, and knowledge of where a mobile device 100 is position with respect to the body 10 (e.g., front pocket, back pocket, or right hand).

FIG. 4 shows sensor measurements taken along two complementary paths, in accordance with some embodiments. A path is defined as a route between a first point (point A) and a second point (point B). A forward path (or first path) follows the path from point A to point B. A reverse path (or second path) follows the path from point B to point A. In some embodiment, a heatmap is only created from a common mobile device 100 that travels the first and second paths. In other embodiments, similar mobile devices 100 but not necessarily a common mobile device 100 travels the forward and reverse paths. In still other embodiment, any mobile device 100 traveling the forward path is paired to another mobile device 100 traveling the reverse path. An overall heatmap may be limited to WiFi measurements of users with common and/or similar mobile devices 100 travelling from point A to point B or from point B to point A. By pairing sensor measurements in any of these embodiments, sensor bias and/or overall system bias may be removed or minimized from an overall heatmap.

FIG. 5 shows sensor measurements taken along a loop, in accordance with some embodiments. A loop is defined as a route that crosses a common point (e.g., point A) twice during its travel. Sensor bias may be removed from sensor measurements when a mobile device 100 travels in a loop. In some embodiments, an overall heatmap is formed with sensor measurements from mobile devices 100 travelling in loops and excludes sensor measurements from mobile devices 100 not travelling in loops.

FIG. 6 shows complementary sensor measurements taken along two hallways, in accordance with some embodiments. A heatmap may be formed for each individual access point 200. Measurements used (e.g., sensor measurements and/or wireless signal strength measurements) may be used in complete sets. A complete complementary set may be defined as entering and leaving a single point A and/or may require one set of measurements from each direction and path to and from an access point.

In the example shown in the figure, a complementary set requires a north-south pair (i.e., northbound measurements and southbound measurements) as well as two east-west pairs (i.e., eastbound measurement of a user travelling away from the access point with westbound measurement of a user travelling towards the access point, and westbound measurement of a user travelling away from the access point with eastbound measurement of a user travelling towards the access point).

A complementary set may require a predetermined set of measurements from and/or to an access point. For example, a heatmap for a particular access point 200 at a turn of a hallway is formed with a complementary set of measurements where the complementary set requires measurements from one or more mobile devices 100 travelling north, south, east and west. Each set may be limited to a common mobile device 100 or similar mobile devices 100, or unlimited by mobile device 100.

Crossing common points A and B (e.g., as in FIG. 4) or a single point A (e.g., as in FIGS. 5 and 6) may be determined by the mobile device 100 itself, a location server executing position estimation or by user intervention. For example, a user may provide user input at a particular point and then the mobile device 100 forwards this information to a location server.

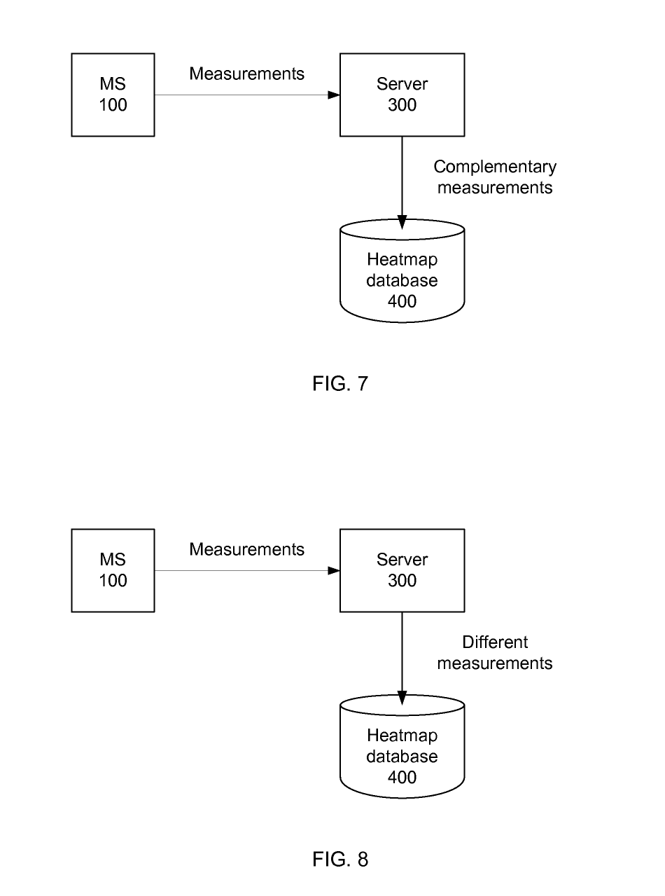

FIGS. 7 and 8 illustrate complementary and distributed measurements being saved to a heatmap database 400, in accordance with some embodiments. In FIG. 7, a mobile device 100 wirelessly communicates measurements to a server 300, such as a location server. The measurements are at least sensor measurements from one or more sensors and may also contain wireless signal strength measurements from one or more access points 200. When pairing complementary sets of sensor measurements, the server 300 receives a first set of measurements captured when travelling from point A to point B. The server 300 hold the sensor measurements until the server 300 receives a second set of measurements captured from the same, a similar or a different mobile device 100 travelling from point B to point A. After a pair is found, the server 300 creates or updates a heatmap database 400 with sensor measurements in the pair. If a second set of measurements is not received that complements the first set, for example, within a predetermined time or before a timer times out, the first set of measurements may be treated as extra measurements and may be discarding and not used to in the heatmap. Using crowdsourcing, several pairs or sets of measurements are used to create a heatmap database 400, and an eventual heatmap, while excluding unpaired measurements.

In the example above, two complementary measurements are paired (as in FIG. 4). Alternatively, a set of two or more paths and directions may be paired. Sensor measurements complete a set of paths and directions. The complementary set may then entered into a heatmap database 400 to create or update a heatmap while excluding unpaired measurements. For example, a set requires two directions in a first hallway and two directions, on each side of an access point, in a second hallway (as shown in FIG. 6). After the server 300 receives one set of sensor measurements for each path and direction, the complementary set may be used to create or updated the heatmap.

In FIG. 8, a mobile device 100 wirelessly communicates measurements to a server 300, such as a location server. The measurements are at least wireless signal strength measurements, such as RSSI measurements, from one or more access points 200 and/or at least wireless round-trip time measurements, such as RTT measurements, from one or more access points 200. The measurements may also contain sensor measurements from one or more sensors. The measurements are distributed such that an even balance of different measurements are grouped and saved to the heatmap database 400. Measurements that represent a common direction relative to an access point that are not matched with different measurements in a different direction are ignored or discarded. A different direction may be directions that differ by at least 30 degrees. By grouping measurements from different directions together as a set and then only using these sets in the heatmap database 400, biases introduced to a heatmap with only similar data is excluded.

In some embodiments, the server 300 may determine an absolute direction or a relative direction of the mobile device 100 relative to each access point 200. The wireless signal strength measurements may be increased based on the direction of travel of the mobile device 100 and the position of the mobile device 100 relative to a body 10. The server 300 may assume a body position relative to the access point 200 and the mobile device 100. For example, if the direction of travel is away from the access point 200, then a signal strength from the wireless signal strength measurements is increased to counter a body induced attenuation. If the direction of travel is directly towards the access point 200, then the signal strength from the wireless signal strength measurements is not adjusted because the body does not attenuate the WiFi signal received by the mobile device 100. The wireless signal strength measurements are saved to the heatmap database 400 after any direction-based adjustment.

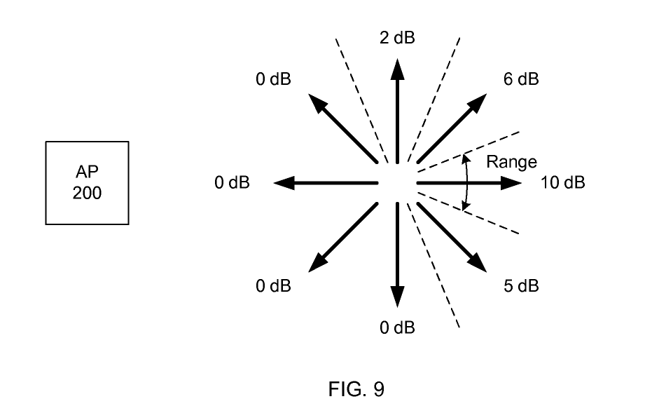

FIG. 9 illustrates a direction of travel of a mobile device 100 relative to an access point 200, in accordance with some embodiments. An amount of signal strength adjustment is a function of assumed body induced attenuation based on a direction of travel and assumed or known placement of the mobile device 100. In the case, a signal strength for a mobile device travelling approximately directly away from an access point 200 with the mobile device 100 in a front pocket is increased by 10 dB. In this top-down view, a mobile device 100 travelling approximately perpendicular to the access point 200 is increased by 0 to 2 dB. A mobile device 100 travelling approximately between these directions is increased by 5 to 6 dB. A mobile device 100 travelling towards the access point 200 is not adjusted. The adjustments may be asymmetric (as shown) or symmetric. For example, the assumed body attenuation may be skewed to model a majority of right-handed users. The adjustments may be skewed to reflect a majority of user wearing their phones either in their right-front pocket or at their right-front waist. Amplification values may be determined after experimentation with a pool of sample users.

The adjustment may be either 0 dB or a single predetermined amount. For example, wireless signal strength measurements are adjusted by 6 dB when a mobile device 100 is travelling away from an access point 200 and otherwise left unadjusted. The adjustment may be either 0 dB or plurality of discrete values. For example, as shown in FIG. 9, a signal strength amplification is set for each range of directions of travel of the mobile device 100 relative to the access point 200.

In other embodiments, WiFi measurements are not adjusted based on body attenuation. Instead pairs or sets of various measurements as discussed above are averaged together. In some embodiment, locations of various access points 200 are unknown and the derived heatmap is used to locate access points 200.

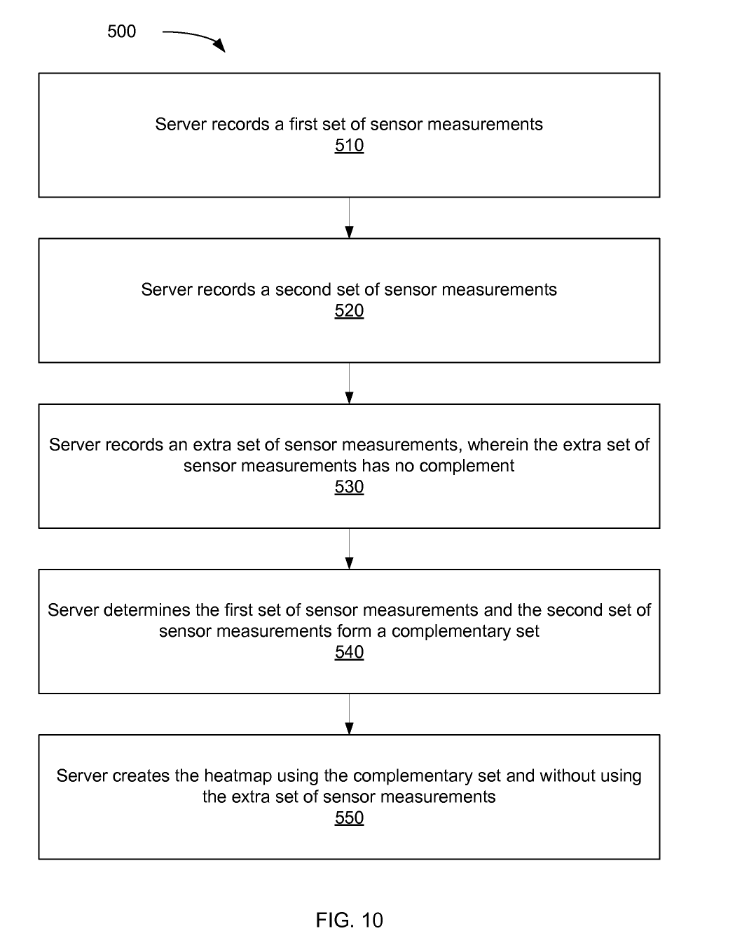

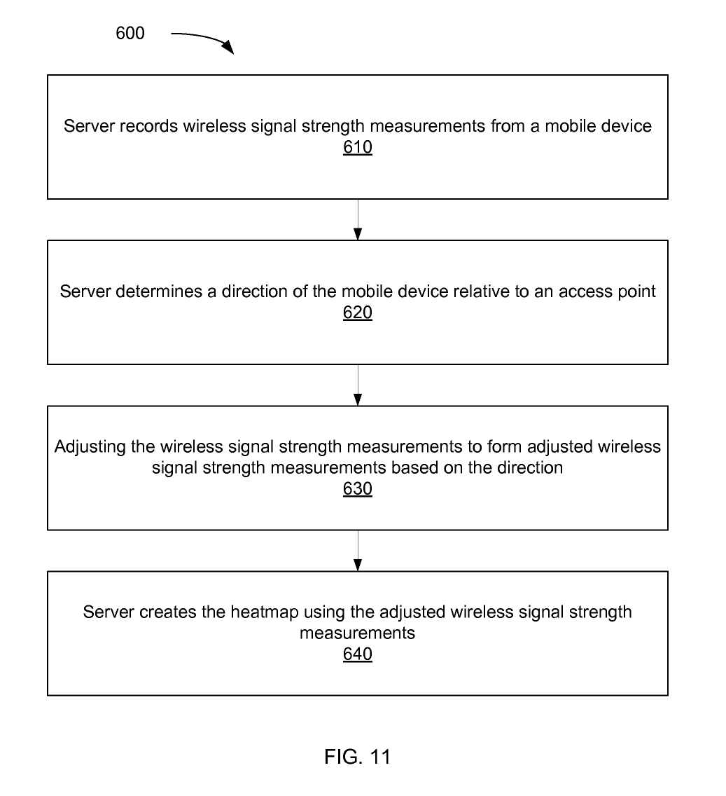

FIGS. 10 and 11 show methods 500 and 600 performed in a server 300 for deriving a heatmap, in accordance with some embodiments. Methods 500 and 600 may be performed separately or together.

In FIG. 10, a method 500 creates or updates a heatmap based on complementary sensor measurements. At 510, a server 300 records a first set of sensor measurements from a mobile device 100. At 520, the server 300 records a second set of sensor measurements a mobile device 100. In some embodiments, a common mobile device 100 provides both the first and second set of sensor measurements. In other embodiments, the first set of sensor measurements and the second set of sensor measurements are provided by different mobile devices 100. In other embodiments, the first set of sensor measurements and the second set of sensor measurements are provided by one or more mobile devices 100 travelling in opposite directions. The process may continue recording a third and/or fourth sets of sensor measurements.

At 530, the server 300 records an extra set of sensor measurements, wherein the extra set of sensor measurements has no complement. That is, in the future the server 300 will not receive another set of sensor measurements (e.g., before timing out) that complements the extra set of sensor measurements. The server 300 does not know a priori that a particular set of sensor measurements will be extra or paired with one or more sets of sensor measurements.

At 540, the server 300 determines the first set of sensor measurements and the second set of sensor measurements form a complementary set. Some embodiments requiring more than two sets of sensor measurements to form a complete complementary set. For example, for a particular access point 200, a complete complementary set may require two directions from each nearby hallway before being used for a heatmap. At 550, the server 300 creates or updates the heatmap using the complementary set while excluding the extra set of sensor measurements.

In FIG. 11, a method 600 creates or updates a heatmap based on adjusted wireless signal strength measurements. At 610, a server 300 records wireless signal strength measurements from a mobile device 100. The set of sensor measurements may include a mobile device determine direction of travel or a direction the mobile device 100 is facing. Alternatively, the server 300 determines a direction of travel of the mobile device 100 (and thus an assumed relative position of the mobile device 100, access point 200 and a human body 10) based on previous estimated position of the mobile device 100.

At 620, the server 300 determines a direction of the mobile device 100 relative to an access point 200. Again, the mobile devices 100 may be a common mobile device 100 or different mobile devices 100. The direction may be a direction of travel of the mobile device 100 computed by either the mobile device 100 or the server 300 from a previous estimated position. Alternatively, the direction may be an orientation of the mobile device 100 as communicated by the mobile device 100.

At 630, the server 300 adjusts the wireless signal strength measurements to form adjusted wireless signal strength measurements based on the direction of travel. At 640, the server 300 creates or updates the heatmap using the adjusted wireless signal strength measurements and non-adjusted.

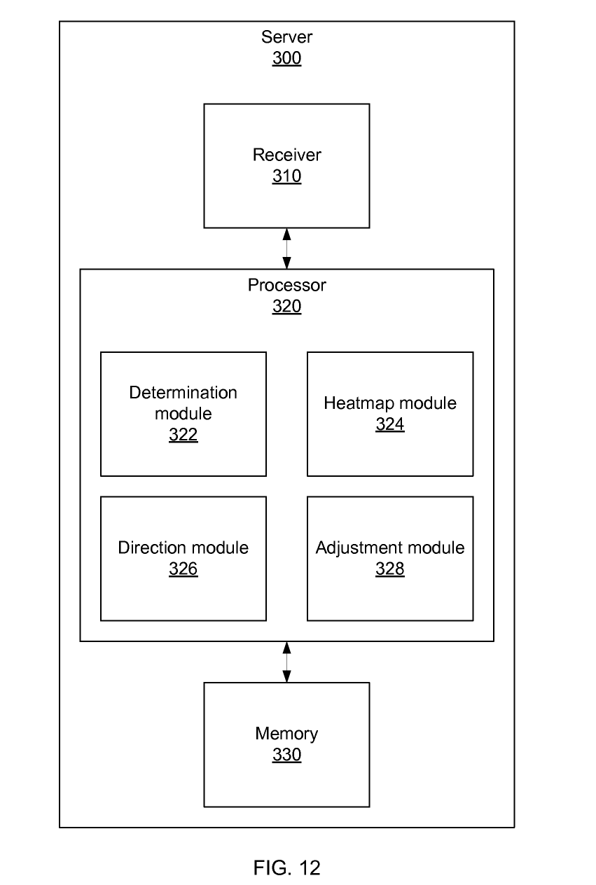

FIG. 12 shows blocks of a server 300, in accordance with some embodiments. The server 300 includes a receiver 310, processor 320 and memory 330 couple directly together and/or via a bus.

The receiver 310 may be part of a transceiver, which communicates through wired and wireless channels to a mobile device 100 through access points 200 and a communications network. The receiver 310 receives multiple sets of sensor measurements and/or wireless signal strength measurements from one or more mobile devices 100. The receiver 310 acts as a means for receiving. The received measurements may be recorded to memory 330.

The processor 320 executes software modules held in memory 330. The processor 320 acts as a means for processing. The memory 330 may be integrated with or separate from the processor 320. The software modules include a determination module 322, a heatmap module 324, a direction module 326 and/or an adjustment module 328.

The determination module 322 determines if the sets of sensor measurements form a complementary set. The complementary set may be formed with just the first and second sets of sensor measurements or may be formed with three or more sets of sensor measurements. Alternatively or in addition to, the determination module 322 determines a direction of travel of the mobile device 100 relative to an access point 200. The determination module 322 acts as a means for determination.

The heatmap module 324 creates and updates the heatmap using the complementary set while excluding the extra set of sensor measurements. The heatmap module 324 acts as a means for creating the heatmap. Alternatively or in addition to, the heatmap module 324 creates and updates the heatmap using the adjusted wireless signal strength measurements.

The direction module 326 determines a direction of travel of the mobile device 100 relative to an access point 200. The direction module 326 acts as a means for determining a direction of travel of the mobile device 100.

The adjustment module 328 adjusts the wireless signal strength measurements to form adjusted wireless signal strength measurements based on the direction of travel of the mobile device 100. The adjustment module 328 means for adjusting the wireless signal strength measurements based on the direction of travel. In some embodiments, a server for deriving a heatmap comprises a receiver, which acts as a means for recording a first set, a second set and an extra set of sensor measurements. The first set of sensor measurements complements the second set of sensor measurements. The extra set of sensor measurements has no complement. The server further comprises a processor, which acts as a means for determining the first set and second set of sensor measurements form a complementary set. The processor further acts as a means for creating the heatmap using the complementary set while excluding the extra set of sensor measurements. Furthermore, a nonvolatile memory may contain code to enable the server's receiver and processor to execute the instructions above.

The methodologies described herein may be implemented by various means depending upon the application. For example, these methodologies may be implemented in hardware, firmware, software, or any combination thereof. For a hardware implementation, the processing units may be implemented within one or more application specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, electronic devices, other electronic units designed to perform the functions described herein, or a combination thereof.

For a firmware and/or software implementation, the methodologies may be implemented with modules (e.g., procedures, functions, and so on) that perform the functions described herein. Any machine-readable medium tangibly embodying instructions may be used in implementing the methodologies described herein. For example, software codes may be stored in a memory and executed by a processor unit. Memory may be implemented within the processor unit or external to the processor unit. As used herein the term “memory” refers to any type of long term, short term, volatile, nonvolatile, or other memory and is not to be limited to any particular type of memory or number of memories, or type of media upon which memory is stored.

If implemented in firmware and/or software, the functions may be stored as one or more instructions or code on a computer-readable medium. Examples include computer-readable media encoded with a data structure and computer-readable media encoded with a computer program. Computer-readable media includes physical computer storage media. A storage medium may be any available medium that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to store desired program code in the form of instructions or data structures and that can be accessed by a computer; disk and disc, as used herein, includes compact disc (CD), laser disc, optical disc, digital versatile disc (DVD), floppy disk and Blu-ray disc where disks usually reproduce data magnetically, while discs reproduce data optically with lasers. Combinations of the above should also be included within the scope of computer-readable media.

In addition to storage on computer readable medium, instructions and/or data may be provided as signals on transmission media included in a communication apparatus. For example, a communication apparatus may include a transceiver having signals indicative of instructions and data. The instructions and data are configured to cause one or more processors to implement the functions outlined in the claims. That is, the communication apparatus includes transmission media with signals indicative of information to perform disclosed functions. At a first time, the transmission media included in the communication apparatus may include a first portion of the information to perform the disclosed functions, while at a second time the transmission media included in the communication apparatus may include a second portion of the information to perform the disclosed functions.

The previous description of the disclosed aspects is provided to enable any person skilled in the art to make or use the present disclosure. Various modifications to these aspects will be readily apparent to those skilled in the art, and the generic principles defined herein may be applied to other aspects without departing from the spirit or scope of the disclosure.

What is claimed is:

1. A method in a server for deriving a heatmap, the method comprising:
recording a first set of sensor measurements;
recording a second set of sensor measurements;
recording an extra set of sensor measurements, wherein the extra set of sensor measurements has no complement;
determining the first set of sensor measurements and the second set of sensor measurements form a complementary set;
forming the complementary set from the first set of sensor measurements and the second set of sensor measurements; and
creating the heatmap using the complementary set while excluding the extra set of sensor measurements.

2. The method of claim 1, further comprising:
recording a third set of sensor measurements;
recording a fourth set of sensor measurements;
wherein determining the first set of sensor measurements and the second set of sensor measurements to form the complementary set comprises determining the first set of sensor measurements, the second set of sensor measurements, the third set of sensor measurements and the fourth set of sensor measurements form the complementary set.

3. The method of claim 1, wherein the complementary set comprises an opposite direction between the first set of sensor measurements and the second set of sensor measurements.

4. The method of claim 1, wherein the complementary set comprises a different direction between the first set of sensor measurements and the second set of sensor measurements.

5. The method of claim 1, wherein the first set of sensor measurements and the second set of sensor measurements are from a common mobile device.

6. The method of claim 1, wherein the first set of sensor measurements and the second set of sensor measurements are from different mobile devices.

7. The method of claim 1, further comprises using crowdsourcing, wherein:
recording the first set of sensor measurements comprises recording a plurality of first sets of sensor measurements;
recording the second set of sensor measurements comprises recording a plurality of second sets of sensor measurements;
recording the extra set of sensor measurements comprises recording a plurality of extra sets of sensor measurements;
determining the first set of sensor measurements and the second set of sensor measurements form the complementary set comprises determining the plurality of first sets of sensor measurements and the plurality of second set of sensor measurements form complementary sets; and
creating the heatmap using the complementary set while excluding the extra set of sensor measurements comprises creating the heatmap using the complementary sets while excluding the extra sets of sensor measurements.

8. The method of claim 1, further comprising:
recording a first wireless signal strength measurement;
recording a second wireless signal strength measurement;
recording an extra wireless signal strength measurement, wherein the extra wireless signal strength measurement has no complement;
determining the first wireless signal strength measurement and the second wireless signal strength measurement form a complementary signal strength set; and
forming the complementary signal strength set from the first wireless signal strength measurement and the second wireless signal strength measurement.

9. A server for deriving a heatmap, the server comprising:
a receiver to receive:
a first set of sensor measurements;
a second set of sensor measurements; and
an extra set of sensor measurements; and
a processor to:
determine the first set of sensor measurements and the second set of sensor measurements form a complementary set;
form the complementary set from the first set of sensor measurements and the second set of sensor measurements; and
create the heatmap using the complementary set while excluding the extra set of sensor measurements.

10. The server of claim 9, wherein:
the receiver is further to receive:
a third set of sensor measurements; and
a fourth set of sensor measurements;
wherein the processor to determine the first set of sensor measurements and the second set of sensor measurements to form the complementary set comprises a processor to determine the first set of sensor measurements, the second set of sensor measurements, the third set of sensor measurements, and the fourth set of sensor measurements form the complementary set.

11. The server of claim 9, wherein the complementary set comprises an opposite direction between the first set of sensor measurements and the second set of sensor measurements.

12. The server of claim 9, wherein the complementary set comprises a different direction between the first set of sensor measurements and the second set of sensor measurements.

13. The server of claim 12, wherein the different direction comprises a difference of at least 30 degrees.

14. The server of claim 9, wherein the first set of sensor measurements and the second set of sensor measurements are from a common mobile device.

15. The server of claim 9, wherein the first set of sensor measurements and the second set of sensor measurements are from different mobile devices.

16. The server of claim 9, wherein:
the receiver comprises a receiver to:
receive a plurality of first sets of sensor measurements;
receive a plurality of second sets of sensor measurements; and
receive a plurality of extra sets of sensor measurements;
the processor comprises a processor to:
determine the plurality of first sets of sensor measurements and the plurality of second set of sensor measurements form complementary sets.

17. A method in a server for deriving a heatmap, the method comprising:
recording a first wireless signal strength measurement;
recording a second wireless signal strength measurement;
recording an extra wireless signal strength measurement, wherein the extra wireless signal strength measurement has no complement;
determining the first wireless signal strength measurement and the second wireless signal strength measurement form a complementary set;
forming the complementary set from the first wireless signal strength measurement and the second wireless signal strength measurement; and
creating the heatmap using the complementary set while excluding the extra wireless signal strength measurement.

18. The method of claim 17, further comprising:
recording a third wireless signal strength measurement;
recording a fourth wireless signal strength measurement;
wherein determining the first wireless signal strength measurement and the second wireless signal strength measurement to form the complementary set comprises determining the first wireless signal strength measurement, the second wireless signal strength measurement, the third wireless signal strength measurement and the fourth wireless signal strength measurement form the complementary set.

19. The method of claim 17, wherein the complementary set comprises an opposite direction between the first wireless signal strength measurement and the second wireless signal strength measurement.

20. The method of claim 17, wherein the complementary set comprises a different direction between the first wireless signal strength measurement and the second wireless signal strength measurement.

21. The method of claim 17, wherein the first wireless signal strength measurement and the second wireless signal strength measurement are from a common mobile device.

22. The method of claim 17, wherein the first wireless signal strength measurement and the second wireless signal strength measurement are from different mobile devices.

23. The method of claim 17, further comprises using crowdsourcing, wherein:
recording the first wireless signal strength measurement comprises recording a plurality of first wireless signal strength measurements;
recording the second wireless signal strength measurement comprises recording a plurality of second wireless signal strength measurements;
recording the extra wireless signal strength measurement comprises recording a plurality of extra wireless signal strength measurements;
determining the first wireless signal strength measurement and the second wireless signal strength measurement form the complementary set comprises determining the plurality of first wireless signal strength measurements and the plurality of second wireless signal strength measurements form complementary sets; and
creating the heatmap using the complementary set while excluding the extra wireless signal strength measurement comprises creating the heatmap using the complementary sets while excluding the plurality of extra wireless signal strength measurements.

24. A server for deriving a heatmap, the server comprising:
a receiver to receive:
a first wireless signal strength measurement;
a second wireless signal strength measurement; and
an extra wireless signal strength measurement; and
a processor to:
determine the first wireless signal strength measurement and the second wireless signal strength measurement form a complementary set;
form the complementary set from the first wireless signal strength measurement and the second wireless signal strength measurement; and
create the heatmap using the complementary set while excluding the extra wireless signal strength measurement.

25. The server of claim 24, wherein:
the receiver is further to receive:
a third wireless signal strength measurement; and
a fourth wireless signal strength measurement;
wherein the processor to determine the first wireless signal strength measurement and the second wireless signal strength measurement to form the complementary set comprises a processor to determine the first wireless signal strength measurement, the second wireless signal strength measurement, the third wireless signal strength measurement, and the fourth wireless signal strength measurement form the complementary set.

26. The server of claim 24, wherein the complementary set comprises an opposite direction between the first wireless signal strength measurement and the second wireless signal strength measurement.

27. The server of claim 24, wherein the complementary set comprises a different direction between the first wireless signal strength measurement and the second wireless signal strength measurement.

28. The server of claim 24, wherein the first wireless signal strength measurement and the second wireless signal strength measurement are from a common mobile device.

29. The server of claim 24, wherein the first wireless signal strength measurement and the second wireless signal strength measurement are from different mobile devices.

30. The server of claim 24, wherein:
the receiver comprises a receiver to:
receive a plurality of first wireless signal strength measurements;
receive a plurality of second wireless signal strength measurements; and
receive a plurality of extra wireless signal strength measurements;
the processor comprises a processor to:
determine the plurality of first wireless signal strength measurements and the plurality of second wireless signal strength measurements form complementary sets.
